(19) United States
(12) Patent Application Publication
(10) Pub. No.: US 2006/0060154 A1
(43) Pub. Date: Mar. 23, 2006

(54) Mechanical toys for pet birds

(76) Inventor: Elaine Wesely, Sunnyvale, CA (US)

Correspondence Address: KENYON & KENYON LLP, ONE BROADWAY, NEW YORK, NY, 10004, US

(21) Appl. No.: 10/971,023

(22) Filed: Oct. 25, 2004

Related U.S. Application Data
(60) Provisional application No. 60/611,752, filed on Sep. 22, 2004.

(51) Int. Cl. A01K 29/00

(52) U.S. Cl. 119/709

(57) ABSTRACT

The present invention relates to bird toys that provides mental stimulation, and entertainment for birds as well as satisfies the chewing instinct. Releasable fasteners provide a “puzzle” for the bird to discern how to remove and replace such fasteners. Chewing components provide bird safe chewing surfaces to maintain beak health.

### FIELD OF THE INVENTION

The present invention relates to interactive mechanical toys for pet birds that provide exercise, entertainment, and mental stimulation while also satisfying the natural chewing instinct.

### BACKGROUND OF THE INVENTION

It has been theorized that pet birds, especially parrots, have the mental capacity of a three to five year old human. As such, they require a mentally stimulating atmosphere. Since most birds kept as companions spend substantial amount of time in cages or on play stands, they must be provided with toys that provide mental stimulation to combat boredom. Although often caused by other reasons, self destructive behaviors such as feather chewing, feather plucking, self mutilation and excessive screaming often result from boredom in pet birds.

Parrots also have a natural instinct for chewing. In the wild they must chew out nesting cavities to prepare a suitable nesting site. In addition, chewing helps maintain the beak at the appropriate size and keeps if from overgrowing. If a pet parrot is not provided with suitable chewing material, the bird may resort to chewing his own feathers and may develop beak deformities.

To alleviate boredom and provide chewing material to maintain beak health, many bird owners and caretakers provide toys that the bird can chew on and play with. These toys are most often composed of both destructible materials such as wood, leather and coconut pieces and indestructible materials such as hard plastics and metal.

Common in the industry are two types of toys: hanging toys and foot toys. Hanging toys are those that are hung from the cage, perch or play stand and are often comprised of materials such as wood, plastic beads, cotton rope, leather, coconut husk and hard plastic pieces. Foot toys are free standing toys that the birds can pick up with their feet and chew on or toss. Bird owners usually provide foot toys for their birds for play out of the cage and while playing with the human companion.

Another type of toy on the market is called a foraging toy. In the wild, birds must spend a greater part of their day foraging for food, whereas the companion bird is provided its food for the day in a food bowl. To stimulate the bird's mental capacity and to occupy some of the bird's time and foraging instinct, knowledgeable bird owners will often take some of the bird's favorite foods and hide them in foraging toys. These toys require the bird “work” for its treat by chewing away some material to get to the food or require the bird to figure out how to manipulate the toy to release the treat.

Despite the vast array of bird toys commercially available today, there still remains a need for bird toys that challenge the mental capacity of the bird as well as provide materials that satisfy the chewing instinct. In addition to challenging the bird, the toy must be made of bird safe material and sized appropriately for the type and size of bird. The mechanical bird toys of the present invention fulfill this need.

### SUMMARY OF THE INVENTION

The present invention provides mechanical bird toys that provide mental stimulation, entertainment and satisfy chewing instincts for birds. In one embodiment, the mechanical bird toy comprises an elongated member, at least one chewing component having a hole therein, the hole allowing the chewing component to be releasably placed onto the elongated member; a first fastener releasably fastened to the elongated member proximal to the chewing component; and a second fastener releasably fastened to the elongated member distal to the chewing component; wherein the first and second fasteners releasably hold the at least one chewing component onto the elongated member.

Another embodiment of the present invention provides a mechanical bird toy comprising an elongated member, at least one chewing component having a hole therein, the hole allowing the chewing component to be releasably placed onto the elongated member; a releasable fastener releasably fastened to the elongated member proximal to the chewing component; and a non-releasable fastener that is fastened to the elongated member distal to the chewing component, wherein the releasable and non-releasable fasteners hold the at least one chewing component onto the elongated member.

### BRIEF DESCRIPTION OF THE DRAWINGS

FIG. 1 is a side view of a mechanical bird toy of the present invention modeled as a foot toy.

FIG. 2 depicts a mechanical bird toy of the present invention mounted on a cage.

FIG. 3 is side view of is a side view of a mechanical bird toy of the present invention.

FIG. 4 is a side view of a mechanical bird toy of the present invention.

FIG. 5 is a side view of a mechanical bird toy of the present invention.

### DETAILED DESCRIPTION OF THE INVENTION

The present invention relates to mechanical bird toys that provide mental stimulation and entertainment as well as satisfy chewing instincts and help maintain beak health in avian companions. The materials used in the bird toys of the present invention are made of bird safe materials. For example, it is well known that zinc ingested by a bird can cause serious health issues and can ultimately lead to zinc poisoning and death. Thus, if the mechanical bird toy is sized to be played with by a destructive bird or a bird with sufficient beak strength, any metals used in the mechanical bird toys are preferably comprised of zinc free metals, such as stainless steel or anodized aluminum. Another advantage of stainless steel and anodized aluminum is their strength and thus are not likely to be destroyed by even the strongest of parrot beaks. For smaller and less destructive birds, a hard food grade plastic is suitable and is another preferred material for the toys of the present invention.

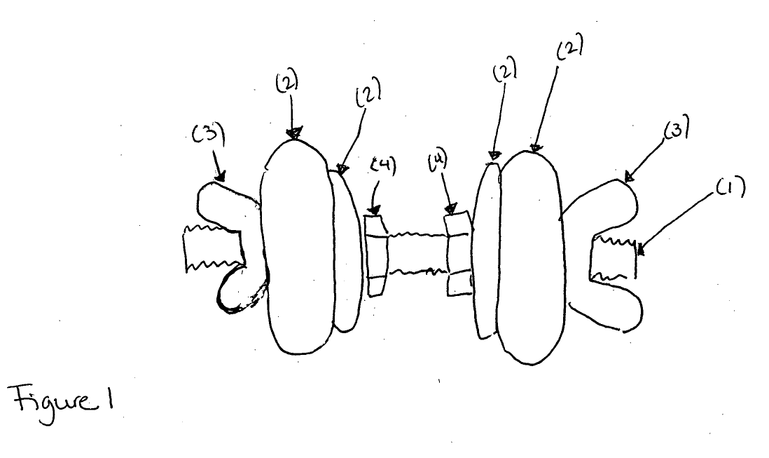

In one embodiment, a mechanical bird toy of the present invention comprises an elongated member 1 and at least one chewing component 2 having a hole therein, which allows the chewing component to be releasably placed onto the elongated member; and a first fastener 3 releasably fastened to the elongated member proximal to the chewing component and a second fastener 4 releasably fastened to the elongated member distal to the chewing component. The fasteners 3 and 4 releasably hold the at least one chewing component onto the elongated member. An example of a mechanical bird toy is shown in FIG. 1.

In another embodiment, a mechanical bird toy of the present invention comprises an elongated member 1, at least one chewing component 2 having a hole therein, which allows the chewing component to be releasably placed onto the elongated member; a releasable fastener 3 releasably fastened to the elongated member proximal to the chewing component; and a non-releasable fastener 5 that is fastened to the elongated member distal to the chewing component, wherein the releasable and non-releasable fasteners hold the at least one chewing component onto the elongated member. An exemplary configuration is a bolt as it provides the elongated member and a non-releasable fastener. In this embodiment, the releasable fastener and the chewing components can be slid on to and off of the elongated member on one end only.

The elongated member is preferably threaded to allow the releasable fasteners 3 and 4 to be threaded onto and off of the elongated member. Alternatively, the elongated member is not threaded and the releasable fasteners are sized such that they can slide onto and off of the elongated member. In this instance, the fit between the releasable fasteners and the elongated member is sufficiently close to provide resistance, allowing the releasable fasteners to stay on the elongated member as well as hold the chewing components in place. The fit is also not so tight so that pressure by the bird can slide the fasteners on and off the elongated member.

Preferably the elongated member is made of stainless steel or food grade plastic and has a diameter and length that is an appropriate for the bird for which the toy is made. The toy should be large enough to provide chewing and handling satisfaction for the bird as well as accommodate the appropriate sized chewing components, but not so large in diameter or long that the bird can not grasp and hold the toy with either its beak or talons. For example, for conures, cockatiels, and other smaller birds, the elongated member is preferably about ¼ inch in diameter and about three inches long. For birds such as small cockatoos, African greys, and amazons, the elongated member is preferably about ⅜ inch in diameter and about four inches long. For large birds such as large cockatoos and large macaws, the elongated member is preferably about ½ inch in diameter and about five inches long.

The chewing components are comprised of any bird safe material. Exemplary chewing components include coconut shells, wood, stainless steel, natural or man-made stone, hard plastic, straw, leather, cotton rope, sisal rope, nylon rope and palm leaves. Any combination of chewing components can be used in the mechanical bird toys of the present invention.

The chewing components are manufactured, drilled or designed to have a hole that allows the chewing component to be placed onto the elongated member. For example, wood, coconut pieces and leather can be drilled to have the appropriate sized hole to slide onto the elongated member. When the chewing component is comprised of materials such as rope, straw, and palm leaves they may be designed like a donut or ring to have a opening. Alternatively, these materials may be simply tied onto the elongated member. Often companion parrots find pleasure in untying knots.

The shape of the chewing components can be varied to provide visual and oral interest. For example wood chewing components can be any shape such as, but not limited to, donut shaped, geometric shapes such as cubes, or triangles; irregular shaped or shaped like holiday novelties like stars, pumpkins, Christmas trees, shamrocks, hearts, etc. Food grade and bird safe dyes may be used to dye the chewing components to provide more visual interest for the bird. Alternatively, the chewing components can be left in their natural color.

The chewing components are preferably sized for the birds. For example, a wood donut of two to three inches in diameter may be appropriate for a large macaw but would be too large for a small parakeet. The wood can also be varied for the type of bird. For example, strong beaked parrots may prefer hard wood such as manzanita and oak whereas smaller parrots whose beak strength is not as strong may prefer softer wood such as pine and balsa.

Certain birds enjoy “shredding” materials in addition to chewing. In this case, the chewing components may comprise materials such as straw, rope, and palm leaves.

Chewing components may also comprise very hard materials such as natural and man made stones, coral, etc. These materials are useful as many birds enjoy rubbing their beaks against them to maintain proper beak length.

Chewing components may also comprise stainless steel pieces to provide entertainment for the bird as noise-makers and shiny reflective surfaces.

Releasable fasteners are any fasteners that can be placed onto and removed from the elongated member repeatably. In a preferred embodiment the releasable fasteners can be screwed onto and off of a threaded elongated member. Exemplary releasable fasteners include wing nuts, hex nuts, square nuts, pal nuts, eye nuts, T nuts, castle nuts and framing nuts. Preferred fasteners, for their ease of obtaining, are hex nuts and wing nuts. Additionally, wing nuts provide surfaces that enable the bird to more easily grasp the nut and unscrew from the elongated member. Any combination of releasable fasteners can be used.

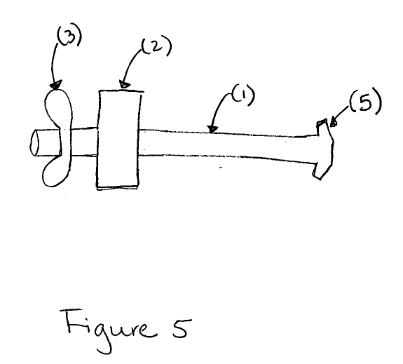

Non-releasable fasteners are any fasteners that are attached to the elongated member and can not be removed by the bird. The non-releasable fasteners can be by design non-releasable, i.e. a bolt by its design provides the elongated member and the non-releasable fastener. An example of this embodiment is shown in FIG. 5. Alternatively, the non-releasable fastener may be any fastener that has been rendered non-fastenable by mechanical means such as welding together or by gluing together. An example of this embodiment is where a wing nut has been placed onto an elongated member and welded on so that the wing nut does not move.

In addition to holding the chewing components onto the elongated member, releasable fasteners provide entertainment and mental stimulation. The bird must first discern how to disassemble the mechanical toy and then may use its beak, tongue or talons to release the fasteners and the chewing components from the elongated member. Further, the bird may enjoy placing the fasteners back onto the elongated member.

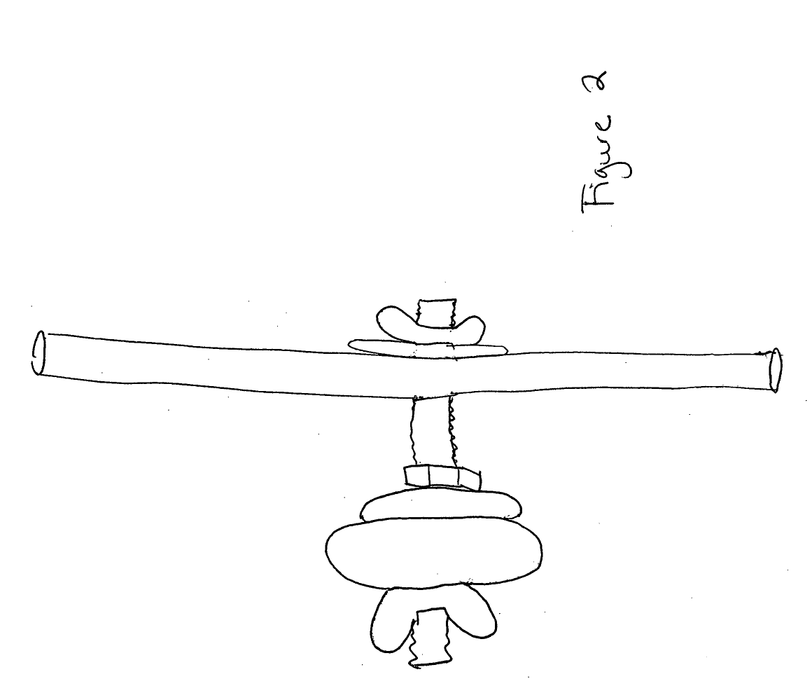

Mechanical bird toys of the present invention may be configured to be used as either a foot toy are may be attached at one end to a bird cage using standard bird safe materials and cage hardware. See FIG. 2.

Mechanical bird toys of the present invention can be varied infinitely to suit the birds' likes/dislikes and to alleviate boredom with an “old” toy. For example, the bird owner or caretaker may configure the mechanical bird toy for one week to have wood chewing components died red and shaped like hearts. Then after the bird has destroyed the chewing components, the owner/caretaker can use a different material and shape for the chewing component, for example a coconut disk and hard plastic bead.

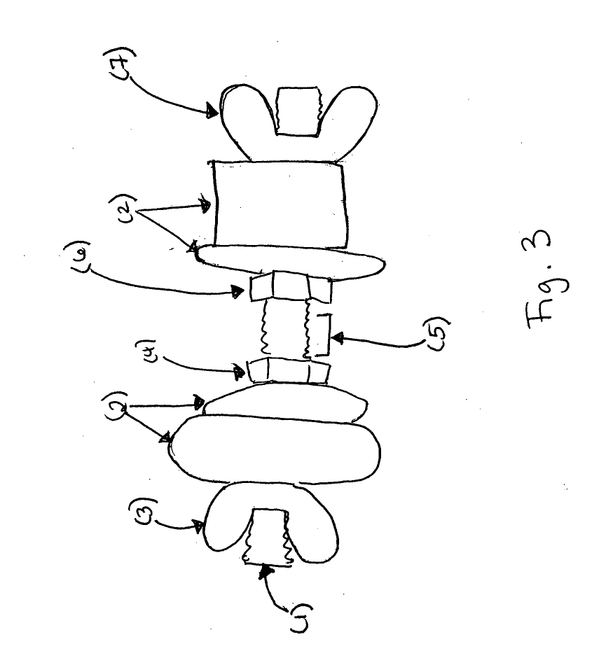

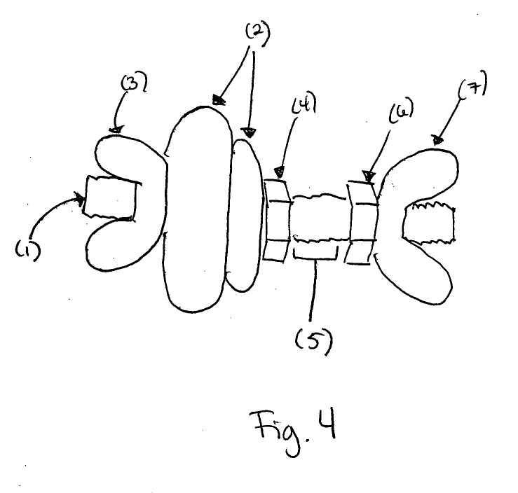

The mechanical bird toys of the present invention may comprise as many releasable fasteners as desired as long as there are two to hold the chewing components in place on the elongated member. For example, a mechanical bird toy may comprise a releasable fastener 3 proximal to one or more chewing components 2, and then a releasable fastener 4 distal to the chewing components. Proximal to the releasable fastener 4 is a distance 5 to allow talon or beak gripping onto the elongated member 1. Proximal to distance 5 is another releasable fastener 6, chewing component 2, and releasable fastener 7. See FIG. 3. In addition, releasable fasteners may serve alone as the “toy” and need not necessarily have chewing components disposed between. For example, as shown in FIG. 4, one end of the mechanical bird toy comprises only releasable fasteners 6 and 7 and no chewing component. As discussed above, the releasable fasteners themselves provide entertainment by challenging the bird to figure out how to remove them and optionally place them back onto the elongated member.

As is apparent from the description of the mechanical bird toys above, the mechanical birds toys of the present invention are refillable, reusable, and can be taken apart for cleaning and disinfecting.

We claim:

1. A mechanical bird toy comprising
a) an elongated member;
b) at least one chewing component having a hole therein, the hole allowing the chewing component to be releasably placed onto the elongated member;
c) a first fastener releasably fastened to the elongated member proximal to the chewing component; and
d) a second fastener releasably fastened to the elongated member distal to the chewing component; wherein the first and second fasteners releasably hold the at least one chewing component onto the elongated member.

2. The mechanical bird toy of claim 1 wherein the elongated member and the first and second fastener is comprised of stainless steel.

3. The mechanical bird toy of claim 1 wherein the elongated member is about ¼ inch in diameter.

4. The mechanical bird toy of claim 1 wherein the elongated member is about ⅜ inch in diameter.

5. The mechanical bird toy of claim 1 wherein the elongated member is about ½ inch in diameter.

6. The mechanical bird toy of claim 1 wherein the elongated member is threaded and the releasable fasteners are selected from the group consisting of wing nuts and hex nuts.

7. A mechanical bird toy comprising
a) an elongated member;
b) at least one chewing component having a hole therein, the hole allowing the chewing component to be releasably placed onto the elongated member;
c) a releasable fastener releasably fastened to the elongated member proximal to the chewing component; and
d) a non-releasable fastener non-releasably fastened to the elongated member distal to the chewing component; wherein the releasable and non-releasable fasteners hold the at least one chewing component onto the elongated member.

8. The mechanical bird toy of claim 7, wherein the elongated member and non-releasable fastener comprise a bolt.

9. The mechanical bird toy of claim 8, wherein the releasable fastener is a wing nut.
